(19) United States
(12) Patent Application Publication
(10) Pub. No.: US 2005/0264213 A1
(43) Pub. Date: Dec. 1, 2005

(54) Electrode system for a high-pressure discharge lamp

(75) Inventors: Anton Dambacher, Adelschlag (DE); Helmut Davideit, Aichach (DE); Klaus Meyer, Pollenfeld (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munchen (DE)

(21) Appl. No.: 10/524,429

(22) PCT Filed: Nov. 19, 2004
(86) PCT No.: PCT/DE04/02561

§ 371 Date: Feb. 15, 2005

(30) Foreign Application Priority Data
Feb. 23, 2004 (DE) 102004008746.6
Mar. 12, 2004 (DE) 102004012242.3

(51) Int. Cl. H01J 17/04; H01J 61/04

(52) U.S. Cl. 313/631

(57) ABSTRACT

The electrode system (13) for a high-pressure discharge lamp comprises at least a pin-like shank (4) having a filament (5), fitted in the vicinity of the discharge-side free end, as its head and a connection part (8) connected to the filament, an encircling winding (11) being fitted to the connection part (8), filament and winding being connected to one another via a spacer (24).

### TECHNICAL FIELD

The invention is based on an electrode system for a high-pressure discharge lamp in accordance with the preamble of claim 1. It deals in particular with electrodes for high-pressure discharge lamps which contain mercury and/or sodium. One example of an application area is metal halide lamps, and another is in particular sodium high-pressure lamps.

### PRIOR ART

EP 587 238 and WO 95/28732 have already disclosed an electrode system for a high-pressure discharge lamp in which an electrode and a leadthrough are used, with a filament fitted to the electrode shank. At the same time, an encircling winding is fitted to the leadthrough. This winding serves partly to improve the sealing action and to protect against corrosion, but in particular, in the case of ceramic discharge vessels, the filament fills the dead volume in the capillary; moreover, the coefficient of thermal expansion of the molybdenum material which is customarily used is better matched to that of Al₂O₃. The filament often consists of tungsten, in order to be able to withstand the high temperatures in the vicinity of the discharge. It is more important for the winding to be compatible with the soldering glass, and consequently in this case a molybdenum wire is generally used. The leadthrough is generally larger than the shank, and accordingly the winding is made from wire which is much thicker than the filament. Standard electrode systems for low wattages up to approximately 100 W are often in three parts, the leadthrough being configured in two parts with a connection part to the electrode shank formed from a molybdenum pin and a niobium pin as the end piece. Higher-wattage lamps are often formed from three or four parts and generally use a cermet part in the form of a pin as the connection part.

### SUMMARY OF THE INVENTION

It is an object of the present invention to provide an electrode system in accordance with the preamble of claim 1 which improves the operating properties of high-pressure discharge lamps and in particular also achieves better light flux and maintenance properties.

This object is achieved by the characterizing features of claim 1. Particularly advantageous configurations are to be found in the dependent claims.

A further object is to provide a lamp having an electrode system of this type.

This object is achieved by the characterizing features of claim 18.

The invention provides a rigid connection between filament and winding, which improves the quality and leads to more reproducible results in the lamp performance. Therefore, there is a fixed distance relationship between filament and winding, so that the precise alignment of the winding which is in any case required automatically results in precise alignment of the filament. A relationship of this nature has not hitherto been considered, on account of the completely different profile of requirements for filament and winding.

The basic construction of the electrode system is of no importance to the fundamental principle of the invention. In general, the electrode system at least comprises an electrode shank with a head, which is configured as a filament, and a connection part. An encircling winding is fitted at least to a part of the connection part.

On one side, the connection part may be integrally connected to the electrode shank. In this case, the integral part generally comprises a pin made from tungsten.

However, the connection part may also be a separate part. In this case, it is often structurally combined with a part of the leadthrough which is fitted to the connection part. Connection parts made from molybdenum, tungsten or cermet are customary. In this case, the diameter of the connection part is often significantly (up to 150%) or even considerably (up to 400%) greater than the diameter of the electrode shank. The concept of the invention can take account of the fact that if there is a very considerable difference in diameter between the filament and the winding, these two parts are made from separate workpieces which are connected to one another. A typical rigid connection can be achieved, for example, by welding, soldering or winding.

However, the invention has particular advantages if the diameter of electrode shank and connection part are selected such that they do not differ excessively, specifically by no more than 50%, and in particular are equal to within 20%. In this case, filament and winding can be produced as a single piece from one wire. Filament and winding are connected to one another via what is known as a winding interruption. This technique has the advantage that filament and winding are fitted to the electrode system directly in a single operation rather than, as has hitherto been customary, having to be produced separately and then fitted separately and with considerable difficulty. Therefore, this new technique represents a quantum leap in terms of reducing costs and improving quality for electrode systems and high-pressure discharge lamps produced using these systems.

In particular, the invention puts the specialists in the field in a position to simplify and reduce the costs of producing ceramic discharge vessels equipped with electrodes. In this context, in particular the development of lamps with low power is also an important application, since the simple and reliable production process for the first time allows low manufacturing tolerances, in particular for low wattages in the range from 20 to 75 W.

Standard electrode systems are in three parts and comprise an electrode shank made from tungsten and a two-part leadthrough having a connection part made from molybdenum, onto which the winding is fitted, and an end piece made from niobium. The connection part often also consists of an electrically conductive cermet, consisting of approximately equal amounts of molybdenum and Al₂O₃, as is known per se. This embodiment is more usual for relatively low wattages up to 150 W. The winding on the connection part may be modified by the addition of a further winding. This further winding may have approximately identical properties to the first winding and form an additional, second layer of the same material on the first winding, or may also consist of a different material or may be designed as a wire which is coiled on the actual winding in order to provide further stability.

A further embodiment for higher wattages (150 to 400 W) uses a four-part electrode system, in which case an intermediate piece, generally a cermet, is introduced between connection part, often made from molybdenum, and end piece, often made from niobium.

In general, the various components of the electrode system, which is usually formed from two to four parts, are welded or soldered or mechanically connected, for example by crimping or plug connection.

The electrode system according to the invention can be used in both ceramic and glass discharge vessels for high-pressure discharge lamps. In this context, it is of no importance whether the discharge vessel is closed on one or two sides. The electrode is bent over in the case of the pinching being on one side. The electrode is held in the discharge vessel by means of its shank, for example using a leadthrough which is part of the shank or fitted to it, this leadthrough being sealed in a ceramic capillary, as is known per se, or in a pinch or fused seal.

The filament on the electrode shank may end flush with the shank or also may protrude or be offset with respect thereto.

This allows particularly simple production of the electrodes. The starting material is, for example, an endless wound formation which includes wound sections and interruptions to the winding. A first wound section may form the filament (W), an adjacent second wound section, which is spaced apart from the first wound section via what is known as an interruption (U) may form the winding (W). In principle, a so-called WUW wound formation of this type can be produced and used in any desired length, in particular with any desired length of the wound segments and the interruptions.

A typical lamp with at least one electrode system has at least one discharge vessel which contains metal vapor, in particular mercury and/or sodium, with the discharge vessel being made from glass or ceramic. These are preferably relatively low-wattage lamps with a power of 20 to 400 W. However, higher-wattage lamps, for example up to 2000 W, are also not ruled out.

The preferred production process for producing an electrode system may also be modified in such a way that a core pin which is assembled from two parts of different diameters is used instead of a continuous core pin which combines the role of the shank and the connection part.

The endless wound formation is preferably cut into sections by means of wire EDM or by the application of laser pulses. A wound formation of this type has a good dimensional accuracy. The filament can no longer slip. The filament remains flush with the end of the core pin. There is now no possibility of the filament dropping off in the event of strong loads.

Moreover, a defined heat transfer is generated. The electrode parameters within a product batch now remain constant, so that the contact and therefore initial heat transfer after the lamp has started between filament and shank is also virtually identical for all lamps. Separate means for securing the filament, such as for example protuberances as described in DE-A 198 08 981, are now no longer required. A further advantage of the new production method is that the electrode can no longer be bent, on account of the fact that it is not pushed on. The extremely gentle production process means that splices are no longer formed in the electrode region, and consequently the blackening behavior and the steadiness of the arc are improved.

The new production process makes it possible to produce extremely simple electrode systems, specifically systems which comprise just two parts and are dimensionally stable even for very low wattages. Hitherto, there has been no production process which is suitable for large industrial production of a 20 W lamp with filament.

Consequently, it is also possible to produce special components which function as front pieces of the electrode system and in particular are highly symmetrical. The advantage of symmetrical electrode systems or of components which form front pieces is that as a result the first or only weld which connects the components of the electrode system to one another is arranged further away from the discharge arc, thereby minimizing the problem of overheated weld spots and the bending of electrode heads.

At a high power, for example 150 to 600 W, an inexpensive three-part design is now possible instead of a complex four-part design, since the length of a front piece can be tailor-made, with the result that in this case too the welded joint can be displaced out of the hot zone. A further advantage is that the more suitable cermet can be used in cooler regions. Hitherto, a three-part design was not possible for high wattages, since on the one hand a cermet material is not sufficiently thermally stable and on the other hand a displacement of the core pin into the leadthrough is ruled out on account of the large dead volume which is formed in the capillary as a result of this measure. On the other hand, it is also not possible to use a molybdenum pin, since the seal is then insufficient. A large pin made from molybdenum is insufficiently well adapted to the ceramic of the capillary in terms of the coefficient of thermal expansion.

The novel process for producing an electrode system with filament and winding makes the production considerably simpler and less expensive and also facilitates automation.

The novel electrode is eminently suitable for production by means of laser. An Nd-YAG laser is typically used for this work. The laser can be used as a cutting tool or for material machining, in particular removal. In the first case, a particularly straight, burr-free cut is achieved, while in the second case it is possible to achieve a protruding core pin at the tip of the electrode in a simple, contact-free manner. A further application area of the laser is that the cross-sectional area of the spacer can thereby be locally reduced in a well-designed way. This partial removal of material leads to a reduction in the heat flux between filament and winding. This allows both the height and the width of the wire to be reduced. It is preferable for the height to be reduced since this allows the external diameter to be reduced at this point. The distance to the capillary of a ceramic discharge vessel is increased as a result, thereby reducing the risk of cracking.

A further possible application is the reduction in the thickness of the winding, in that the height of the last turns is subsequently reduced. This advantageously ultimately improves the welding properties and also the embedding into the fused ceramic, which in this case surrounds the connection pin.

A reduction in height by 30 to 65% is typical. This is important in particular at low wattages up to 100 W.

In particular, it is possible to provide an additional winding around the connection part. This may be produced separately and if appropriate pushed on retrospectively. However, it may also be produced integrally directly from the wire of the wound formation. It may be in one-layer or two-layer form and may be realized as a single or double wound formation. A further possibility is a single-layer coiled-around wound formation.

### BRIEF DESCRIPTION OF THE DRAWINGS

The invention is to be explained in more detail below on the basis of a number of exemplary embodiments, and in the drawing:

FIG. 1 shows a high-pressure discharge lamp, in section;

FIG. 2 shows a further high-pressure discharge lamp, in section;

FIG. 3 shows an electrode system for the lamp shown in FIG. 2, in section;

FIGS. 4 to 13 show further exemplary embodiments of electrode systems.

### PREFERRED EMBODIMENT OF THE INVENTION

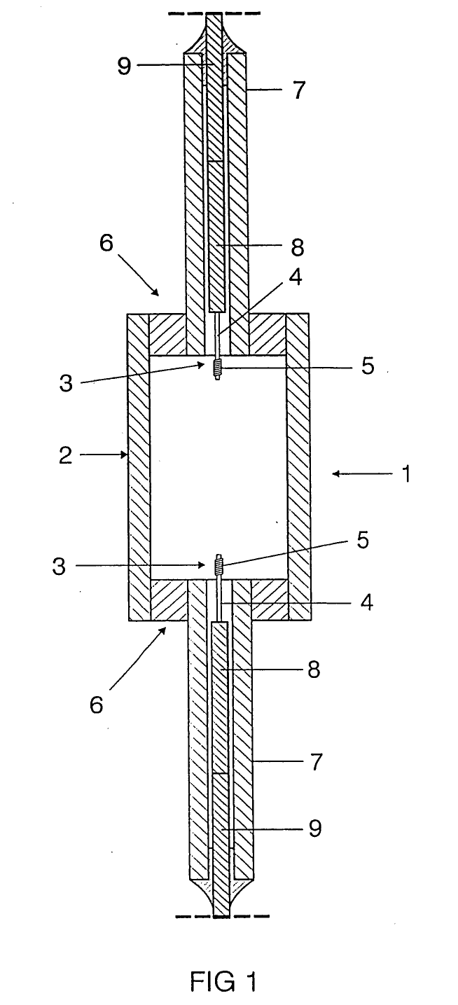

FIG. 1 diagrammatically depicts an excerpt of a metal halide lamp 1 with a ceramic discharge vessel 2 that is closed on two sides and has a power of 150 W. The electrodes 3 comprise pins 4 which as the electrode shank have a constant diameter of approximately 500 μm. A filament 5 with a diameter of 180 μm has been fitted to the shank 4 at a distance of 0.3 mm from the discharge-side tip of the pin. A metal halide fill has been introduced into the discharge vessel 2. The ends 6 of the discharge vessel are closed by means of capillaries 7 which tightly surround a two-part leadthrough 8, 9, comprising an inner connection part 8 and an outer end piece 9. The end piece 9 is a niobium pin.

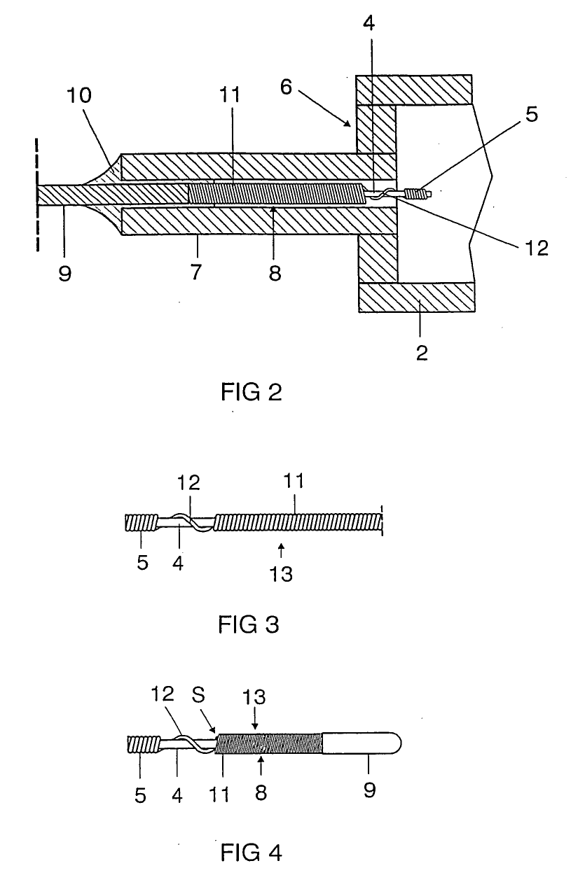

FIG. 2 shows a detailed view of one end of the discharge vessel 2. The end piece 9 is sealed in the capillary 7 by means of soldering glass 10. The connection part 8 consists of molybdenum. It is a pin (covered) which is surrounded by a winding 11 made from molybdenum. The diameter of the connection part 8 is considerably larger than that of the core pin 4, which functions as the shank, of the electrode. The filament 5 which is located on the shank and serves as the electrode head is connected to the winding 11 via an interruption 12 which comprises one or more turns. The number of turns is preferably from 1 to 3.

FIG. 3 diagrammatically depicts another exemplary embodiment of an electrode system 13 for the lamp shown in FIG. 2 in detail. It comprises a continuous pin 4 which serves simultaneously as the shank and the connection part. A filament 5, which comprises approximately 6 turns of a wire and is cut off flush, is fitted to the discharge-side end. A winding 11 of the same wire, which consists of tungsten, is fitted to the leadthrough-side end. This winding 11 comprises approximately 30 turns. Filament 5 and winding 11 are produced integrally and are connected via an interruption 15 which comprises one turn. The distance between filament and winding corresponds to approximately three times the length of the filament 5.

In general terms, the distance between filament and winding preferably increases with the wattage.

In FIG. 4, the electrode system 13 is of similar construction to that shown in FIG. 3. However, the filament 5 and winding 11 are not integral, but rather are separate. The winding 11 is made from molybdenum, since this material is most suitable for matching the coefficient of thermal expansion of the ceramic of the capillary 7. However, on account of the relatively low melting point of molybdenum, electrode systems of this type may not be subjected to excessively high loads, in other words, these systems are eminently suitable for powers of up to 100 W but are only of limited use for powers above this level. Other materials which are suitable for the electrode system include tungsten, tantalum and rhenium, alone or in combination. If appropriate, one material may be used as a coating on another. The wire diameter of the winding 11 is considerably smaller than that of the filament 5, in order to minimize the dead volume. Filament and winding are connected to one another via a weld spot S at the end of the interruption.

The electrode system 13 is completed by the end piece 9 of the leadthrough made from niobium of considerably larger diameter being welded onto the connection part 8. The external diameter of the winding and the diameter of the niobium pin are approximately equal.

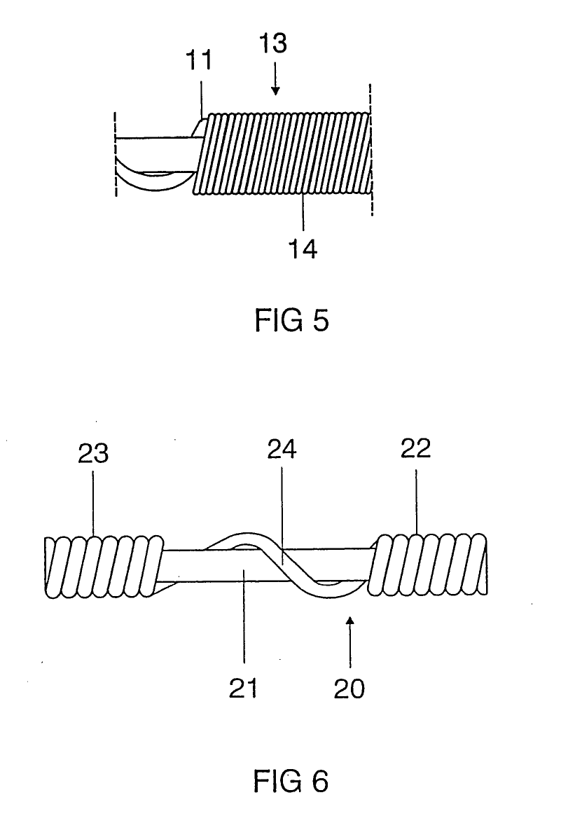

In one preferred embodiment, the solution to the problem of the thermal matching consists in making the winding from a suitable combination of materials. This applies in particular to lamps which are subject to high levels of loading. FIG. 5 shows an excerpt from an electrode system 13, in which the problem of matching the coefficient of thermal expansion with respect to the material of the capillary is solved by a second wound formation 14, which consists of molybdenum, being fitted onto the actual winding 11, which consists of tungsten and is integral with the filament, as shown in FIG. 3. The wound formation 14 is generally made from wire which is thinner, generally 20 to 50% thinner, with a view to minimizing the dead volume.

FIG. 6 shows part of an electrode system which uses a standard component as front piece 20 at that end of the electrode system which is exposed to the discharge. This standard component comprises a core wire 21, which forms the shank and the adjoining first section of the connection part. The filament 22 is mounted on the first end of the shank, specifically in particular in such a way that the filament 22 ends flush with the shank. The winding 23, which is of the same length as the filament 22, is mounted, likewise flush, at the second end of the shank, with an interruption 24 arranged in between. On account of the identical length of filament 22 and winding 23, the component is symmetrical, which hugely simplifies use in production, since the symmetry means that no attention need be paid to the orientation of the component during assembly. In other words, filament and winding are in this case designed as identical parts which can be swapped over.

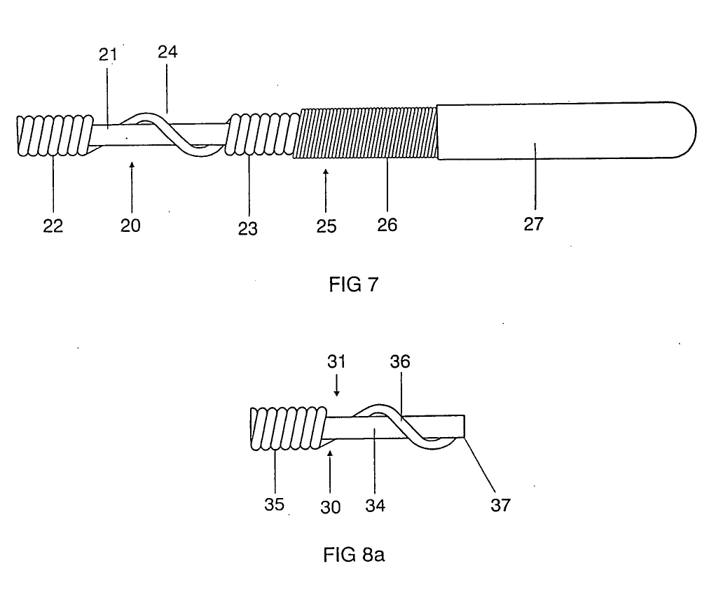

FIG. 7 shows how the front piece 20 is fitted to further components of the leadthrough. The front piece 20 is welded to a center part or intermediate piece 25 made from cermet which is surrounded by a separate winding 26. The end piece 27 made from niobium is attached to the latter, likewise by welding. Therefore, the conventional boundaries between electrode and leadthrough are eliminated, which yields design benefits.

The particular advantage of this arrangement is that in this case the external diameter of the winding 23 and of the separate wound formation 26 of the center part 25 do not have to be equal, since the front piece 20 can be optimized, in terms of geometry and material, to the requirements of the filament 22, whereas the center part 25 can be optimized with a view to an encapsulating and sealing action in the capillary.

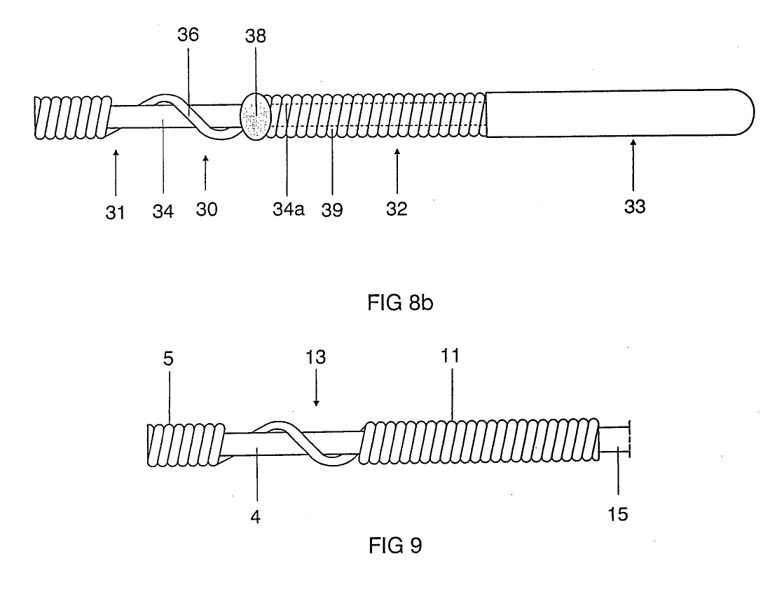

FIGS. 8a and 8b show an electrode system 30 which demonstrates the advantages of a fixed distance between filament 35 and winding 39. The front piece 31 is of novel configuration in accordance with FIG. 8a. By contrast, connection part 32 and end piece 33 can be of conventional design, i.e. for example by a molybdenum wound formation 39 being fitted onto a molybdenum pin 34a (indicated by dashed lines) and being welded to an end piece 33, which is a niobium pin. In this case, a front piece 31 which, in accordance with FIG. 8a, comprises a shank 34 made from tungsten, to which a filament 35 made from tungsten has been fitted, is used. In addition, however, an interruption 36 is also wound onto the shank 34 and extends as far as the rear end 37 of the shank.

In accordance with FIG. 8b, this front piece 31 can be welded to the conventional connection part 32. The highly diagrammatically illustrated welded connection point 38 connects not only the core pins 34 and 34a but also the interruption 36 to the winding 39. In this case too, geometry and materials can be optimized for the specific requirements which are enforced, on account of the decoupled arrangement of front piece and center part.

FIG. 9 shows an electrode system 13 in which the structural unit has a core pin 4 as shank and integral connection part. Whereas the filament 5, as is customary, is seated at the discharge-side end of the shank 4, the winding 11 is longer than the connection part 4′ which it conceals, so that the end piece can be pushed into the cavity 15 at the rear end of the connection part and then crimped. This makes it possible to dispense with the need for a welding operation.

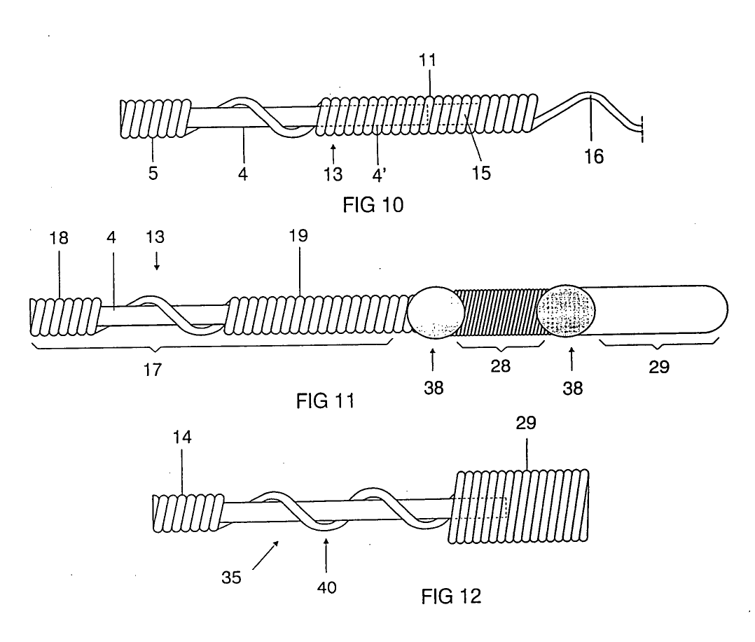

FIG. 10 shows an alternative to FIG. 9, in which the only difference is that an additional interruption 16 is fitted at the rear end of the connection part 4′, specifically without a core pin. In this exemplary embodiment, the end piece is inserted into the cavity 15 and crimped by interruption 16.

FIG. 11 shows an electrode system 13 with a three-part design: an asymmetric front piece 17 with a continuous core pin 4, which forms the shank and the first part of the connection part. A short filament 18 and a long winding 19 are seated on this core pin. A cermet pin 28 with a surrounding molybdenum wound formation is welded to it, and an end piece 29 is in turn welded to this cermet pin 28. The weld spot is in each case denoted by 38.

FIG. 12 shows a front piece 35 in which the interruption 40 is two turns long. The ratio between external diameter of the filament 14 and external diameter of the winding 29 is in this case 1:3. A suitably dimensioned centerpiece can be fitted into the winding.

One specific example of suitable dimensions is a 70 W lamp in which the shank 21 has a diameter of 250 μm and the wire which is wound onto it for filament and winding has a diameter of 150 μm. A symmetrical front piece produced therefrom (cf. FIGS. 6 and 7) has a filament 22 which is 1.1 mm long, an interruption 24 (1 turn) which is 1.8 mm long and a winding 23 which is once again 1.1 mm long. A center part 25 which is fitted thereto and has molybdenum wire 26 wound around it is 8.5 mm long, with a core pin with a diameter of 400 μm and a wound wire with a diameter of 140 μm. An end piece 27 made from niobium fitted thereto is 16.8 mm long and comprises a niobium pin with a diameter of 730 μm.

The dimensions for a 35 W lamp are as follows: the niobium pin 27 has a diameter of 610 μm; the molybdenum core pin 25 of the center part has a diameter of 300 μm and has a molybdenum wire 26 with a diameter of 130 μm wound around it; the core pin 21, which acts as a continuous part for electrode shank and connection part, has a diameter of 154 μm; a filament 22, interruption 24 and winding 23 made from a wire with a diameter of 122 μm are wound onto it.

The dimensions for a 150 W lamp are as follows: the niobium pin 27 has a diameter of 880 μm; the molybdenum core pin 25 of the center part has a diameter of 540 μm and a molybdenum wire 26 with a diameter of 150 μm is wound around it; the core pin 21, which acts as a continuous part for electrode shank and connection part, has a diameter of 500 μm; a filament 22, interruption 24 and winding 23 made from a wire with a diameter of 180 μm are wound onto it.

The diameter DA of the connection part may be between 50 and 400% of the diameter DS of the shank.

In general terms, separate filament and winding may be rigidly connected to one another either by the end of the interruption being welded to the start of the winding or of the filament, in which case the interruption is attached integrally either to the winding or filament. Alternatively, the interruption may also be separate from filament and winding, in which case it requires two weld spots. A purely mechanically rigid connection is also possible instead of welding or soldering, etc., for example by the interruption being threaded into the end, which under certain circumstances may be bent over, of the filament or winding, in a similar manner to the techniques which are known for halogen incandescent lamps.

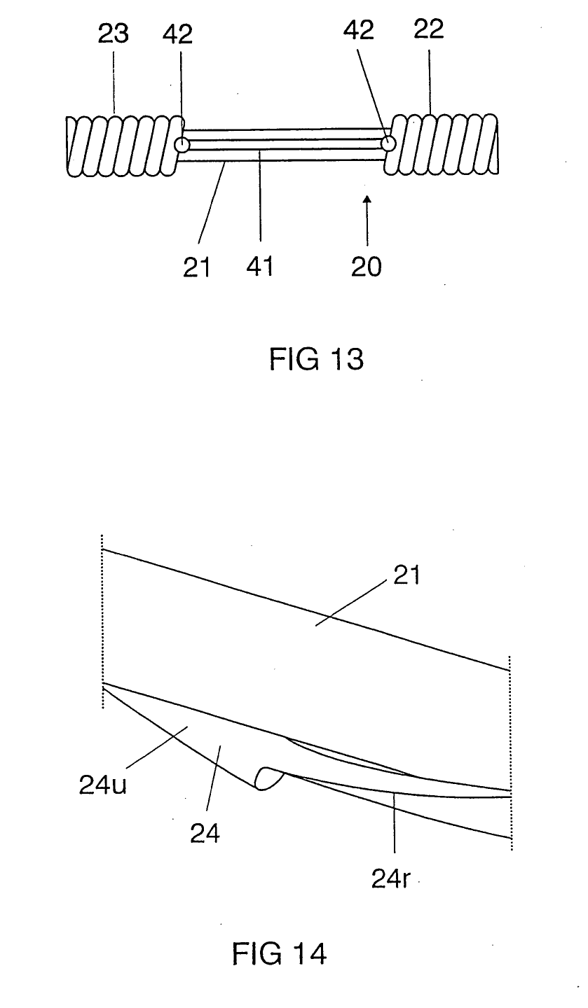

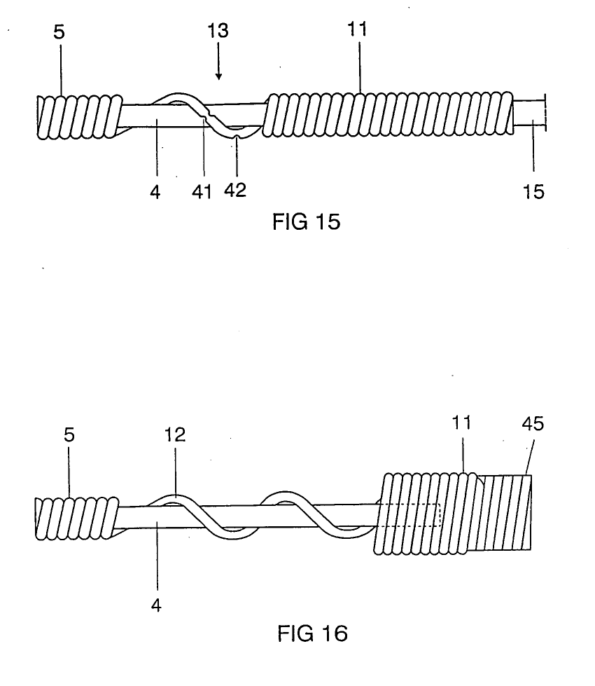

Instead of a winding interruption which is wound helically, it is also possible for the interruption to be designed as a straight spacer 41 which, for example, is inserted between filament 5 and winding 11 via weld spots 42, cf. FIG. 13.

FIG. 14 shows an exemplary embodiment in which the core wire 21 has an interruption 24 wound around it, this interruption 24 in part being an untouched wire section 24u and in part being a wire section 24r whose diameter has been reduced to approximately 60%, which can most easily be realized by laser machining. This suppresses the heat flux from the head of the electrode toward the rear. An alternative is shown in FIG. 15, which in principle shows the illustration corresponding to FIG. 9, except that in this case the interruption is uniformly laterally constricted (41) or is constricted on one side (41). Once again, both of these options can be produced by laser or also by mechanical means.

FIG. 16 shows that an end part 45 of the winding 11, i.e. the part which is at the end remote from the discharge, may have a reduced diameter in order to optimize the region of the winding which is in contact with fused ceramic or soldering glass 10; cf. FIG. 2 for further information. The pin 4 and the interruption 12 and also the filament 5 in this case correspond to the arrangement shown in FIG. 2. In this case too, the reduction in the height in part 45 is best implemented by means of a laser.

1. An electrode system (13) for a high-pressure discharge lamp, at least comprising an electrode, which has a pin-shaped shank (4) with a filament (5) fitted in the vicinity of the discharge-side free end and a connection part (8) connected to the shank (4), and an encircling winding (11) being fitted to the connection part, characterized in that filament (5) and winding (11) are connected to one another via a spacer (41).

2. The electrode system as claimed in claim 1, characterized in that the diameter DA of the connection part is 50% to 400% of the diameter DS of the shank.

3. The electrode system as claimed in claim 1, characterized in that filament (5) and winding (11) are separate parts which are rigidly connected to one another.

4. The electrode system as claimed in claim 1, characterized in that filament (5) and winding (11) form an integral structural unit.

5. The electrode system as claimed in claim 3, characterized in that filament and winding are connected to one another via a winding interruption (24) as the spacer.

6. The electrode system as claimed in claim 1, characterized in that the connection part is a separate part.

7. The electrode system as claimed in claim 1, characterized in that the connection part is an integral extension of the shank.

8. The electrode system as claimed in claim 7, characterized in that at least the shank consists of high-melting, electrically conductive material, preferably of tungsten or tantalum alone or predominantly of tungsten or tantalum.

9. The electrode system as claimed in claim 6, characterized in that the connection part consists of molybdenum, niobium, electrically conductive cermet alone or predominantly of one or an alloy of these materials.

10. The electrode system as claimed in claim 1, characterized in that filament (5) and winding (11) consist of the same material.

11. The electrode system as claimed in claim 1, characterized in that filament and winding consist of molybdenum and/or tungsten.

12. The electrode system as claimed in claim 1, characterized in that filament and winding have the same pitch.

13. The electrode system as claimed in claim 1, characterized in that the electrode system comprises a front piece, in which filament and winding are symmetrical with respect to one another.

14. The electrode system as claimed in claim 1, characterized in that at least one further winding or coiled formation is fitted onto the winding (11) or a part thereof.

15. The electrode system as claimed in claim 1, characterized in that the connection part forms a first part of a leadthrough.

16. The electrode system as claimed in claim 15, characterized in that the leadthrough also comprises a second, end part, which in particular is a niobium pin.

17. The electrode system as claimed in claim 1, characterized in that the connection part has substantially the same diameter as the shank, and in particular in that their diameters differ by less than 30%.

18. The electrode system as claimed in claim 1, characterized in that the diameter of the spacer is locally reduced.

19. The electrode system as claimed in claim 1, characterized in that the height of the winding (11) is reduced at the end remote from the discharge.

20. A high-pressure discharge lamp having at least one electrode system as claimed in claim 1, the lamp having a discharge vessel (2) with two ends, the electrode system being inserted into one or both of these ends of the discharge vessel, the discharge vessel (2) being produced in particular from ceramic.
